(19) United States
(12) Patent Application Publication
(10) Pub. No.: US 2004/0131792 A1
(43) Pub. Date: Jul. 8, 2004

(54) Electroless deposition of cu-in-ga-se film

(76) Inventor: Raghu N. Bhattacharya, Littleton, CO (US)

Correspondence Address: PAUL J WHITE, SENIOR COUNSEL, NATIONAL RENEWABLE ENERGY LABORATORY (NREL), 1617 COLE BOULEVARD, GOLDEN, CO, 80401-3393, US

(21) Appl. No.: 10/451,048

(22) PCT Filed: Mar. 22, 2001
(86) PCT No.: PCT/US01/09304

(51) Int. Cl. B05D 1/18

(52) U.S. Cl. 427/437; 427/250

(57) ABSTRACT

A process for depositing copper-indium-gallium-selenide thin films on substrates, including foreign substrates, occurs in a chemical bath that includes a buffer solution and does not require external current as a catalyst. Formation of the chemical bath includes compounds of each of the constituent elements dissolved in deionized water and the addition of pHydrion buffers likewise dissolved. Deposition occurs as a result of the introduction of both a working electrode and a counter electrode. The deposited thin film is further processed through physical vapor deposition of additional indium, gallium, and selenium in order to fine-tune the stoichiometry of the resultant thin film.

### TECHNICAL FIELD

This invention relates generally to an improved process for the deposition of film on molybdenum-coated glass or other conducting substrate, and more specifically, to an improved process for the concurrent electroless deposition of copper-indium-gallium-diselenide consistently and uniformly with enhanced gallium content in precursor films on a conducting substrate for subsequent recrystallization into CuIn₁₋ₓGaₓSe₂ semiconductor films used in the fabrication of photovoltaic solar devices.

### BACKGROUND ART

Thin films of copper-indium-gallium-diselenide (CIGS) have been the subject of considerable interest and study for semiconductor devices in recent years. These CIGS thin films are of particular interest for photovoltaic device or solar cell absorber applications. For photovoltaic applications, the p-type CIGS layer is often deposited on or under a n-type CdS (cadmium sulfide) layer to form a p-n heterojunction CdS/CIGS semiconductor device. The direct energy gap of CIGS, i.e., no momentum change is required when a charge carrier makes the jump from a valence energy bond to a conduction energy bond, results in a large light energy absorption coefficient, which in turn permits the use of thin layers of CIGS on the order of 1-2 μm, as compared to 150 μm for comparable silicon devices. These CIGS thin film semiconductor devices are also attractive because their solar energy to electrical energy conversion efficiencies have been shown to exceed 17%, and they have long-term stability.

It is generally believed by persons skilled in the art that the best electronic device properties, thus the best conversion efficiencies, are obtained when the mole percent of copper (Cu) is about equal to the mole percent of the indium (In), the gallium (Ga), or the combination of the indium and gallium in the compound or alloy, ideally represented as CuIn₁₋ₓGaₓSe₂. The selenium (Se) content will not generally be important to the electronic properties of the semiconductor if the growth conditions supply sufficient selenium so that it comprises about fifty atomic percent (50 at. %) of the CuIn₁₋ₓGaₓSe₂ compound to form the desired crystal lattice structures.

Several issued patents describe processes that successfully produce a CIGS thin film deposition, but none of these patents disclose an electroless process wherein a chemical bath includes a buffer solution that inhibits the formation of metal oxide and hydroxide precipitates thus effectively increasing the life-span of the deposition solution, nor do any of the disclosed processes concurrently deposit the four constituent elements to produce a CIGS thin film in a manner that produces an efficient concentration of uniformly applied gallium in a commercially cost-effective manner.

U.S. Pat. No. 5,731,031 discloses a process for the electroless deposition of selenide and sulfide salts as films and powders that are then used as precursors for the fabrication of solar cell devices. That electrodeposition process occurs in a chemical bath, which includes a hydrazine reductant in an ammoniacal solution that is adjusted to a pH of approximately 9.9, and it produces a CIGS film layer as well as a powder precipitate. While the deposited CIGS film layer is relatively efficient, the amount of gallium (Ga) deposited is relatively small (see example 4—deposited film composition of Cu_{2.71}In_{0.91}Ga_{0.05}Se₂), and the powder precipitates render the chemical bath unusable, thus forcing a disruption in the continual deposition process and an added expense in its replacement.

U.S. Pat. No. 5,871,630 discloses a process for the electrodeposition of copper-indium-gallium-diselenide (CIGS) thin films for fabricating high efficiency solar cells by utilizing a high-frequency AC voltage in addition to a DC voltage to improve the morphology and the growth rate of the film. The chemical bath, within which the process occurs, is adjusted to a pH in the range of 1.4 to 2.4. In that range, however, the electrolysis of water molecules occurs, and the resulting O²⁻ and OH⁻ ions combine with deposition metal ions to form unwanted metal oxides and hydroxides on the precursor film. To control the electrolysis, the process utilizes organic solvents, such as dimethyl sulfoxide (DMSO). However, the thin films it produces have only minimal gallium content (see examples 1—Cu_{1.00}In_{0.34}Ga_{0.02}Se_{0.91}, 4—Cu_{1.00}In_{0.36}Ga_{0.03}Se_{1.00} and 5—Cu_{1.00}In_{0.46}Ga_{0.01}Se1.16), which has to be corrected by physical vapor deposition of substantial amounts of Ga to attain the necessary stoichiometry for acceptable solar cell performance results. [I.] U.S. Pat. No. 5,976,614 discloses a process for the electroless deposition of copper-indium-gallium-diselenide (CIGS) precursor films and powders onto a metallic substrate. The disclosed process occurs within a chemical bath that has its pH adjusted to an acidic value reported in the range of 2.24-2.6. Although the process deposits relatively gallium-rich precursor films (see examples 1—CuIn_{0.40}Ga_{0.31}Se_{2.17, 3}—CuIn_{0.54}Ga_{0.81}Se_{2.82}, and 15—CuIn_{0.42}Ga_{0.38}Se_{2.04}), it also generates metal oxide and hydroxide precipitates as a result of water molecule electrolysis. Such metal oxide and hydroxide precipitates make it necessary to replace the chemical bath solution at short intervals (an hour or two) and contributes to the overall expense of the thin film deposition and the device fabrication.

Other patents have utilized a variety of processes, but have not been able to incorporate the simultaneous electroless deposition of the four desired elements, Cu, In, Ga, and Se, in the predefined ratio with good morphology.

U.S. Pat. No. 4,325,990 discloses electroless copper deposition with hypophospite and HEEDTA at a pH of 2-3, but this process only deposited a single element, Cu (not a CIGS thin film), and its chemical bath was not a buffer-based medium. U.S. Pat. No. 4,684,550 discloses electroless copper deposition in an alkaline solution of dimethylamine borane, thiodiglycolic acid, surfactant and ammonia. However, this process also deposits only a single element, Cu (not a CIGS thin film), and its chemical bath was not a buffer-based medium, either.

U.S. Pat. No. 4,608,750 discloses electroless deposition of metals aided by photocurrent, but this process does not suggest a CIGS thin film deposition, nor does it utilize a buffer-based medium. U.S. Pat. No. 5,614,003 discloses electroless deposition of nickel, cobalt, copper and tin alloys by using a hydrophosphite reductant in an alkaline fluoborate medium at a pH of 8-11. This process does not disclose a CIGS thin film deposition, nor does it disclose a buffer-based medium. U.S. Pat. No. 5,248,527 discloses electroless deposition for plating tin, lead, or tin-lead alloy on copper or copper alloy using an acidic solution and/or complexing agent. This process, also, does not disclose a CIGS thin film deposition, nor does it disclose a buffer-based medium.

Although a variety of methods exist for the production of CIGS thin film precursors and the subsequent fabrication of solar cell devices, chemical and physical vapor deposition processes are costly, relative to electroceposition and electroless deposition. Accordingly, solar cells fabricated through a vapor deposition process have generally been limited to devices for laboratory experimentation, and are not well-suited for large scale commercial production. Thin film solar cells made by electrodeposition and electroless deposition techniques are generally much less expensive, but they generally suffer from low efficiencies.

Thus, there remains a need in the art of preparing CIGS precursor films for use in photovoltaic solar cell devices to prepare these films by an efficient electroless deposition process. The required process would deposit the constituent elements concurrently, be a low-cost system with a high deposition rate, would be able to continuously produce large-area CIGS precursor thin films at low-temperature without the need for the frequent replacement of the chemical bath, and would be able to initially deposit a significant amount of uniformly applied gallium with a minimal amount of material waste throughout the process. Ideally, the process would also preclude the necessity of utilizing a subsequent costly vapor deposition process to correct the stoichiometry of the resultant thin film.

### DISCLOSURE OF THE INVENTION

Accordingly, it is a general object of the present invention to provide an improved process for the simultaneous electroless deposition of copper-indium-gallium-diselenide thin films to be used in the fabrication of photovoltaic solar cells.

Still another object of the present invention is to provide an improved chemical bath that includes a buffer so that the stability of the electroless deposition process is enhanced and no metal oxides or hydroxides precipitate out of solution.

It is another object of the present invention to provide a process that deposits more gallium in a more uniform manner in the electroless deposition of copper-indium-gallium-diselenide thin films.

A further object of the present invention is to provide an improved electroless deposition process that effectively utilizes the source materials and minimizes process waste generation.

It is yet another object of the present invention to provide an improved electroless deposition process that generates copper-indium-gallium-diselenide thin films that have no contaminating impurities, can be produced at a low temperature and at a high rate for a low cost, and that can be used to produce energy efficient solar cells.

An additional object of the present invention is to provide an improved concurrent electroless deposition process of producing copper-indium-gallium-diselenide thin films with enough concentration of each element that minimal, if any, additional vapor deposition processing is required.

Additional objects, advantages, and novel features of the invention shall be set forth in part in the description that follows, and in part, will become apparent to those skilled in the art upon examination of the following or may be learned by the practice of the invention. The objects and the advantages may be realized and attained by means of the instrumentalities and in combinations particularly pointed out in the appended claims.

To achieve the foregoing and other objects and in accordance with the purposes of the present invention, as embodied and broadly described herein, a first embodiment of an improved concurrent electroless deposition process in accordance with the present invention includes a new deposition bath using a buffer solution, which includes pHydrion buffers dissolved in water, along with the added essential constituent elements of copper, indium, gallium, and selenium, as well as the addition of lithium chloride dissolved in water. A zinc counter electrode is used with a 10-ohm resistor in series. The deposition takes place over the period of about one hour.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

In the Drawings:

FIG. 1 is a cross sectional view of a photovoltaic device that includes a CIGS thin film prepared according to the present invention.

FIG. 2 is a representation of the apparatus required for the electroless deposition of the copper-indium-gallium-selenide thin film that is the basis for the present invention.

FIGS. 3A and 3B are scanning electron microscope photographs of two as-deposited CIGS precursor films that were deposited according to the process of the present invention.

FIG. 4 is a graph of the Auger electron spectroscopy analysis representing the kinetic energy in electron volts versus counts per second of an as-deposited CIGS precursor film that was deposited according to the process of the present invention.

FIG. 5 is a graph of the Auger electron spectroscopy analysis representing the atom percentage of each constituent element versus sputter time in minutes of an as-deposited CIGS precursor film that was deposited according to the process of the present invention.

FIG. 6 is the x-ray analysis of an as-deposited CIGS precursor film that was deposited according to the process of the present invention.

FIG. 7 is a graph of the relative quantum efficiency versus wavelength of an as-deposited CIGS precursor film that was deposited according to the process of the present invention.

FIG. 8 is a graph showing the current versus the voltage characteristics of an as-deposited CIGS precursor film that was deposited according to the process of the present invention.

### BEST MODE FOR CARRYING OUT THE INVENTION

The process of the present invention comprises the steps of preparing the simultaneous electroless deposition of (ideally) CuIn₁₋ₓGaₓSe₂ precursor films. In the invention, x has values that range from 0.1 to 0.5, preferably from 0.25 to 0.3, and ideally, x=0.5. If x=0.5, then the film is stoichiometric, i.e., one part Cu, one part equal amount of In and Ga, and two parts Se. At x=0.25, the device yields a commercially practical band gap of 1.25 eV, which represents a solar cell device that absorbs a wavelength of 1000 nm. As the amount of gallium deposited increases, the band gap also increases. At x=0.5, the device would yield a theoretical band gap of 1.45 eV, which would absorb a different energy band of the solar spectrum than would a device with a lower band gap. Without gallium, devices fabricated with copper-indium-selenide (CIS) thin films yield a band gap of approximately 1.0 eV. Empirically, the best CIGS devices fabricated have a copper content of about 24% and a combined indium and gallium content of about 26%.

In preparing the electroless deposition of CuIn₁₋ₓGaₓSe₂ precursor films of the invention, Fe, Zn, or Al is used as a counter electrode to initiate the electroless deposition of CIGS precursor thin films that are used to fabricate solar cells. The electroless deposition of an ideal CuIn₁₋ₓGaₓSe₂ thin film is caused by a combination of the following electrochemical and chemical reactions:

The following reduction occurs at the working electrode (substrate), where M is a metal:

Mⁿ⁺+ne⁻→M (I)

H₂SeO₃+4H⁺+4e⁻→Se+3H₂O (2)

H₂SeO₃+3H₂O+4e⁻→Se+6OH⁻ (3)

xM+ySe→MₓSe_{y} (4)

and the following oxidation occurs at the counter electrode (Fe, Zn, or Al):

M→Mⁿ⁺+ne⁻ (5)

As a result, the most electropositive redox system (e.g., Cu, In, Ga, H₂SeO₃ or SeO₂) is reduced (deposited).

To control the potential, an external resistor can be applied, and the E⁰ vs. SHE for controlling the potential external resistor in providing the simultaneous electroless deposition of an ideal CuIn₁₋ₓGaₓSe₂ precursor thin film is governed by the following:

Cu²⁺+2e⁻→Cu 0.342 V

Cu¹⁺+e⁻→Cu 0.521 V

In³⁺+3e⁻→In −0.338 V

Ga³⁺+3e⁻→Ga −0.549 V

H₂SeO₃+4H⁺4e⁻→Se+3H₂O −0.740 V

SeO₃²⁻+3H₂O+4e⁻→Se+60H⁻ −0.366 V

Zn²⁺+2e⁻→Zn −0.763 V

Fe²⁺+2e⁻→Fe −0.447 V

Al³⁺+3e⁻→Al −1.662 V

The chemical bath includes compounds of CuCl₂, InCl₃, H₂SeO₃, GaCl₃, and LiCl. Each is dissolved in deionized water. Next, pHydrion buffers are dissolved in water and are added to the chemical bath. The pH of the resulting solution has a pH ˜2. In the preferred embodiment, potassium biphthalate is used as one of the pHydrion buffers. It is also known as phathalic acid or dipotassium salt, and it acts to absorb free OH⁻ and H⁺ ions that exist in the chemical bath as a result from the electrolysis of the water molecules in the acidic solution as shown below:

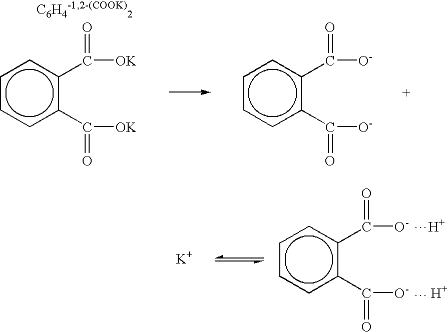

Sulphanic acid, the other pHydrion buffer in the preferred embodiment, also acts to stabilize the chemical bath by absorbing additional OH⁻ and H⁺ ions as shown below:

H₂N+SO₃H⇄H₂N+SO₃⁻+H⁺

In this particular case, the potassium biphthalate and sulphanic acid compliment each other.

Specifically, the preferred embodiment of the buffered chemical bath solution is comprised of 0.75 gm of CuCl₂, 1 gm of InCl₃, 1 gm of H₂SeO₃, 0.6 gm of GaCl₃, and 10 gm of LiCl that are initially dissolved in 200 ml of deionized water. The LiCl does not enter into the chemical reaction, but rather, creates ions to accommodate current flow, which is the reason that this process is not truly electroless even though no external current is utilized. To this aqueous solution, 10.0 gm of potassium biphthalate and sulphamic acid, dissolved in 800 ml of water, are added to complete the chemical bath solution where the electroless deposition of the CIGS precursor thin films occurs.

In the disclosed relevant art, the electroless deposition of the CIGS does not complete the fabrication of the precursor thin film. The as-deposited films are next loaded into a physical vapor deposition chamber, where additional Cu, In, Ga, and Se are added to the film to adjust its final stoichiometric composition. In the PVD chamber, the films are allowed to crystallize at a high temperature. In all of the disclosed relevant art pertaining to electrodeposition or electroless deposition of CIGS precursor thin films, the addition of Cu, In, Ga, and Se by PVD are very crucial steps to obtain high-efficiency solar cell devices.

Currently, the present invention necessarily includes a second step in the fabrication process of high quality, low cost thin film CIGS semiconductor devices that exhibit photovoltaic characteristics and that are especially adaptable for solar cell applications. In the first step, the CIGS precursor thin film is deposited via an electroless process in a chemical bath on a substrate, such as glass coated with molybdenum. The second step is the physical vapor deposition of additional indium, gallium, and selenium (the as-deposited thin films fabricated using the present invention are copper rich, thus do not need additional copper deposition during the PVD stage). In this second step, the composition of the overall film is carefully controlled so that the resulting thin film is very close to the stoichiometry of the ideal precursor film of the chemical bath deposition process, and is described in greater detail below.

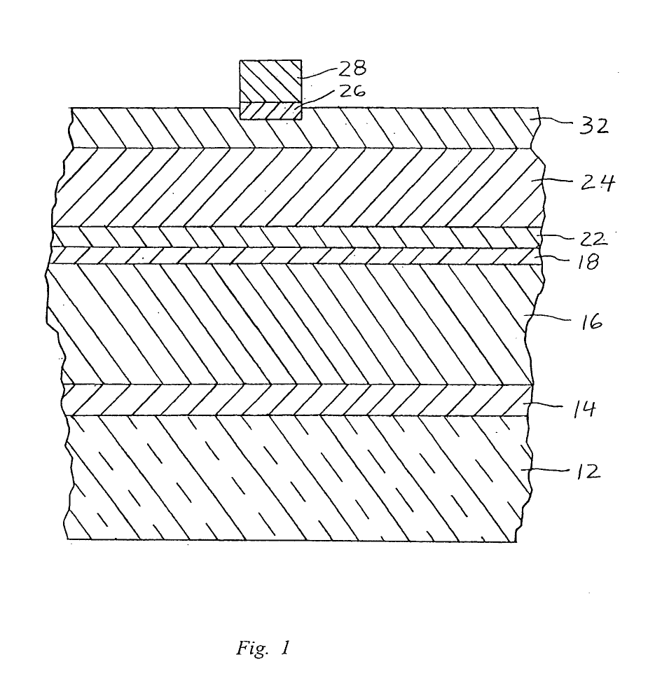

A CdS/CIGS photovoltaic device, 10 which includes a substrate 12, is illustrated diagrammatically in FIG. 1. The substrate 12, may be, for example, soda-lime silica glass. The substrate 12, further includes a back contact layer of molybdenum, which can be about 1-2 μm thick. The molybdenum back layer 14 may be deposited using any deposition methods that is known to persons skilled in the art. To improve adhesion between the Mo layer 14 and the CIGS precursor film 16 to be deposited, an additional adhesion layer of copper (not shown) may also be deposited. After the Mo layer 14 and the optional copper adhesion layer (not shown) have been deposited, the substrate 12 should be degreased and dried using methods that are well known to persons skilled in the art.

A metallic CIGS precursor film 16 is then deposited in bulk using the commercially economical electroless deposition that occurs within the buffer-enhanced chemical bath. This step is then optionally followed by a vapor deposition step, which carefully controls the final metal ratios. The metallic CIGS precursor film 16 should be deposited to about 1-3 μm thick, with thickness being controlled by coulometric measurements. The result is the economical production of a solar cell that exhibits high light energy to electric energy conversion efficiencies and other device quality characteristics. Thin films fabricated by processes disclosed in the relevant art have generally required substantial (on the order of 35-40% indium and gallium deposition) PVD enhancement in order to produce efficient solar cell devices. The process of this invention generating gallium-rich precursor films that require only minimal, if any, PVD enhancement (e.g., on the order of 12-15% indium and gallium deposition by PVD) to yield efficient solar cell devices.

Currently, after the CIGS precursor film 16 has been cleaned by any method known to persons skilled in the art, an additional layer of copper, indium, gallium, and/or selenium is deposited by physical vapor deposition to adjust the final film composition to approximately the preferred Cu:(In,Ga):Se ratio of 1:1:2. By controlling the ratio of In/Ga, the energy band gap between the CdS and the CIGS layers can be adjusted to the optimal or nearly optimal value. A band gap of approximately 1.45 eV is considered optimal for terrestrial solar energy conversion, and is achieved by an In/Ga ratio of approximately 3:1. For solar cells prepared according to the method disclosed herein, a Ga/(In⁺ Ga) atomic ratio of 0.30 is preferred. A higher amount of gallium can increase the band gap to a more optimum band gap level. The substrate (precursor film) temperature should be 300° C. to 600° C. during PVD, and preferably 560° C.±10° C.

After PVD, if PVD is necessary, the films can be annealed to improve the homogeneity and the quality of the films. A high quality CIGS film is one that does not exhibit an excessive amount of copper nodules, voids, or vacancies in the film which would reduce conversion efficiencies. Annealing the films at 250° C. to 500° C. in a vacuum, followed by slow cooling at a rate of approximately 3° C./min to avoid thermal shock has been found to yield good results. Because selenium has a much higher vapor pressure than either copper, indium, or gallium, selenium may be lost from the film during the high temperature steps of vapor deposition and annealing. To compensate, the atmosphere during these steps may contain a moderate selenium overpressure. In the preferred embodiment, the film is selenized at a rate of 5-100 Å/s during cool-down from PVD temperature to annealing temperature.

Once the CIGS layers collectively are deposited and annealed to form the p-type CIGS active layer 16, a thin layer 18 of n-type semiconductor material comprising cadmium sulfide can be deposited on the CIGS active layer 16 to form the heterojunction of a photovoltaic device. The CdS layer 18 is preferably deposited by chemical bath deposition to a thickness of approximately 500 Å in a method that is well known to persons skilled in the art. A layer 24 of conducting wide bandgap n-type semiconductor material, such as n-type zinc oxide/aluminum (n-ZnO:Al), is used to provide an ohmic contact with the CdS. However, before the n-ZnO:Al ohmic contact layer 24 is deposited, a thin insulation layer 22 of zinc oxide (i-ZnO) is deposited on the CdS layer 18 to prevent the conductive n-ZnO:Al layer 24 from melting or diffusing through the CdS layer 18 and shorting the CIGS/CdS heterojunction. In the preferred embodiment, first zinc oxide layer 22 comprising i-ZnO is deposited to the thickness of approximately 500 Å. The second zinc oxide layer 24, comprising approximately 1-5% Al₂O₃— doped zinc oxide (n-ZnO:Al), is deposited to a thickness of approximately 3500 Å using a method that is also well-known to persons skilled in the art.

Bi-layer metal contacts may then be prepared with an e-beam system or other technique. In an exemplary embodiment, a first metal contact layer 26 was 0.5 μm thick Ni and the second metal contact layer 28 was 1-3 μm thick Al. Metal contacts will generally be laid out in fine grid lines across the collecting surface 30 of the device 10 and connected to a suitable current collecting electrode (not shown). The efficiency of the resulting device 10 can be further increased by adding an antireflection coating 32, such as a 1200 Å layer of MgF₂ by electron beam. A device prepared according to the present invention exhibited a conversion efficiency of 12.7%, which is a very high conversion energy relative to the low cost in fabrication using the improved chemical bath deposition process of this invention.

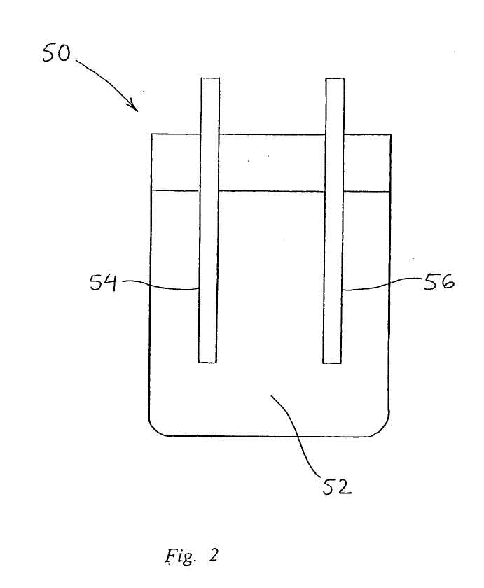

Apparatus 50 for performing the improved process of electroless deposition of copper-indium-gallium-diselenide thin films according to this invention is illustrated in FIG. 2. The deposition bath, itself, which is an important feature of the invention, incorporates a buffer solution 52. The apparatus 50 also includes a working electrode 54, which is the substrate upon which the constituent elements are deposited, and a counter electrode 56 of iron, zinc, or aluminum, which initiates the chemical reaction through its oxidation. No external current or voltage sources are required for this process.

The buffer solutions in the deposition bath of this invention make the solution very stable, and more gallium is consistently and uniformly deposited in the precursor films as a result. In particular, devices in the neighborhood of 12.7% efficiency are created, which are comparable to devices produced using processes disclosed in the relevant art, but which are achieved in a more time and cost effective manner.

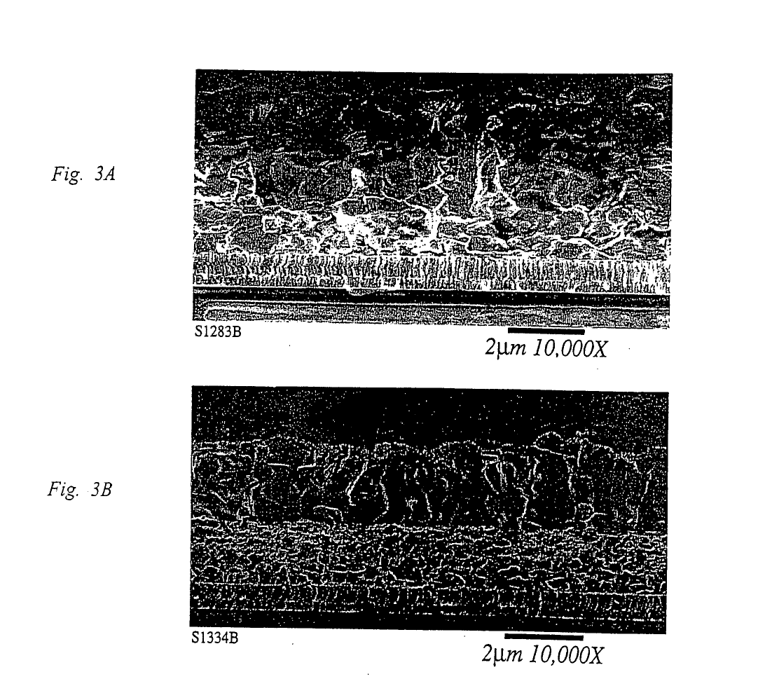

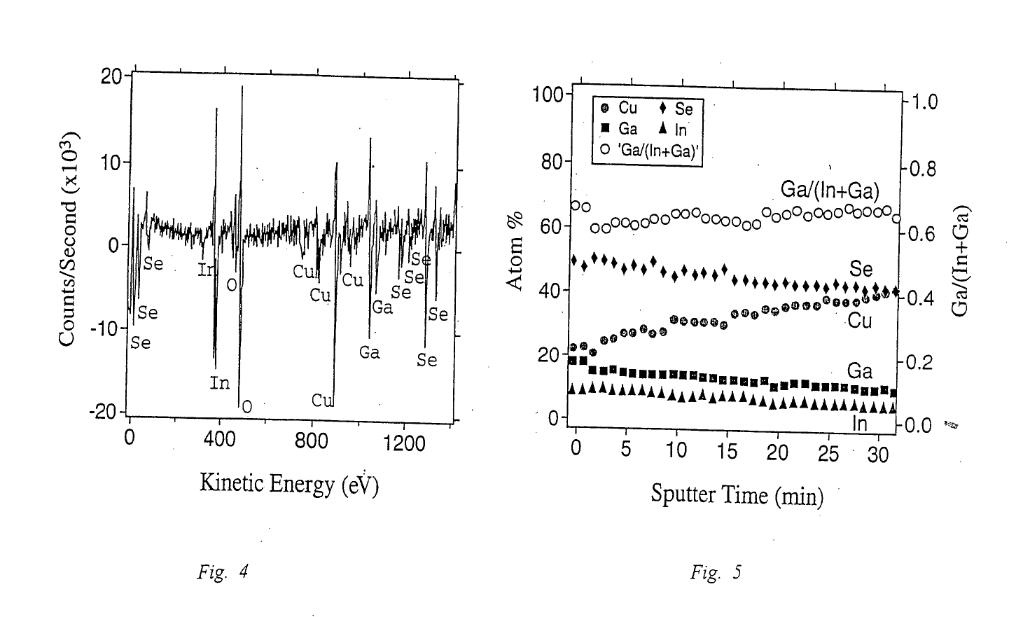

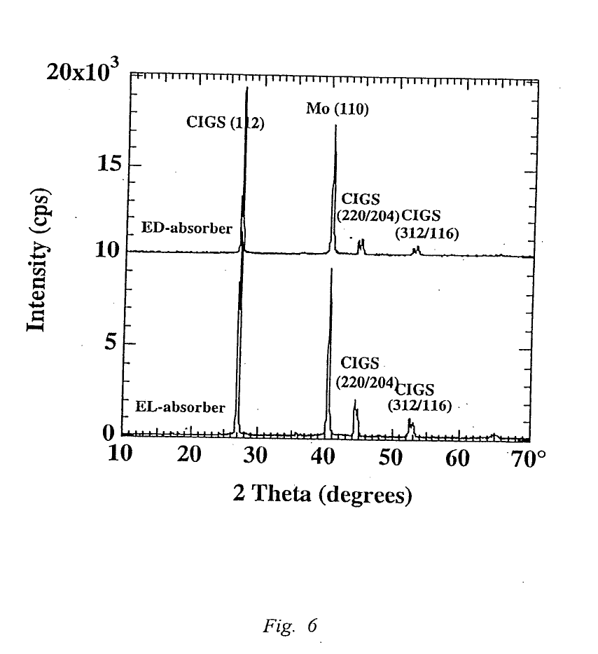

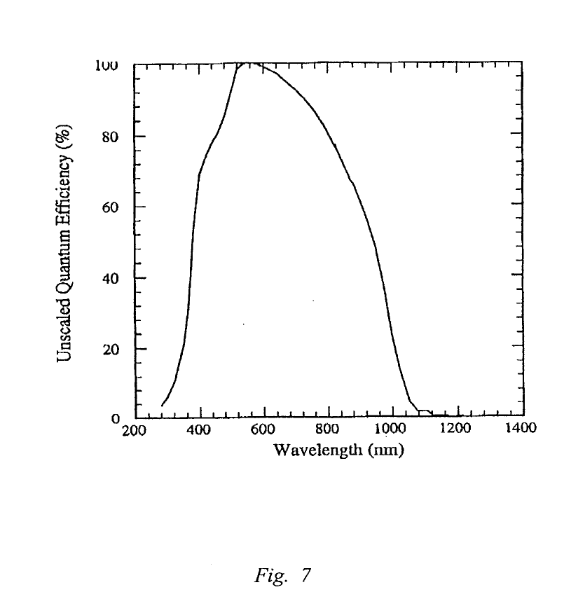

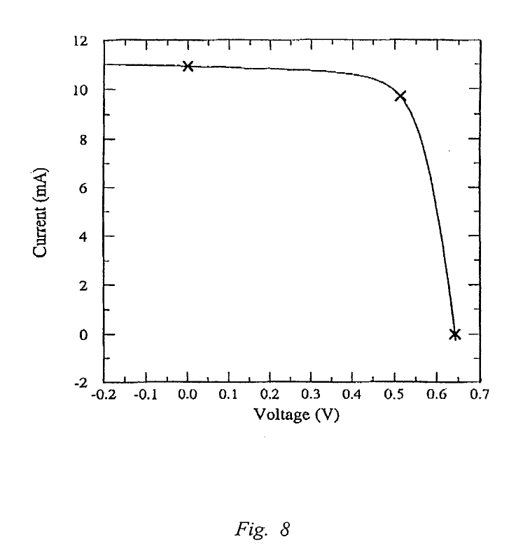

A pair of scanning electron microscope photographs of two as-deposited films according to this invention are shown in FIGS. 3A and 3B. The photographs show the film to be tight, densely packed, and uniform. FIG. 4 and FIG. 5 show the Auger electron spectroscopy (AES) analysis of the finished photovoltaic cell showing the atomic distribution of the film at varying depths within the film. FIG. 6 is the x-ray analysis showing that there were no impurities in the deposited film. FIG. 7 shows the relative quantum efficiency of the solar cell as a function of wavelength. FIG. 8 shows the current versus voltage characteristics of the finished solar cell. The cell exhibited an overall efficiency of 12.7%.

Although the present invention has thus been described in detail with regard to the preferred embodiments and drawings and examples thereof, it should be apparent to persons skilled in the art that various adaptations and modifications of the present invention may be accomplished without departing from the spirit and the scope of the invention. Accordingly, it is to be understood that the detailed description and the accompanying figures as set forth herein are not intended to limit the breadth of the present invention, which should be inferred only from the following claims and their appropriately construed legal equivalents.

1. A method for electroless deposition of a copper-indium-gallium-diselenide precursor film onto a metallic substrate without the need for any external current or voltage source, the method comprising:
preparing an aqueous bath solution within said reaction vessel of a mixture consisting of:
a copper compound;
an indium compound;
a gallium compound;
a selenium compound, with the copper compound, the indium compound, the gallium compound and the selenium compound each in a sufficient quantity to react with each other to produce said copper-indium-gallium-diselenide precursor film;
a lithium compound, or other compound suitable to induce electric current; and a buffer solution to neutralize hydride and hydroxide ions;
immersing the substrate in the solution; and
initiating and maintaining an electrochemical reaction in the solution for a sufficient time to yield a simultaneous deposition of copper, indium, gallium, and selenium from said aqueous bath solution onto said metallic substrate by placing a counter electrode in the solution that is capable of oxidation when exposed to the solution to produce electrons that enable the electrochemical reaction.

2. The method of claim 1, wherein said metallic substrate is selected from a group consisting of molybdenum and a glass substrate coated with molybdenum.

3. The method of claim 1, wherein said counter electrode is selected from a group consisting of iron, zinc, and aluminum.

4. The method of claim 1, wherein said buffer solution is comprised of phydrion buffers dissolved in water.

5. The method of claim 4, wherein said buffer solution is comprised of potassium biphthalate and sulphanic acid.

6. The method of claim 1, wherein said copper-indium-gallium-diselenide precursor film is further comprised of a Ga/(In+Ga) atomic ratio in the range of 0.2 to 0.7.

7. The method of claim 6, wherein said copper-indium-gallium-diselenide precursor film is further comprised of a Ga/(In+Ga) atomic ratio in the range of 0.3 to 0.5.

8. The method of claim 1, wherein said copper-indium-gallium-diselenide precursor film has a band gap in the range of 1.0 to 1.45.

9. The method of claim 8, wherein said copper-indium-gallium-diselenide precursor film has a solar energy to electrical energy efficiency of at least 12.0%.

10. The method of claim 1, wherein said copper-indium-gallium-diselenide precursor film is further comprised of a Cu:(In+Ga):Se atomic ratio of approximately 1:1:2.

11. The method of claim 10, wherein said copper-indium-gallium-diselenide precursor film is subjected to a further vapor deposition process in order to obtain a Cu:(In+Ga):Se atomic ratio of approximately 1:1:2.
